(19) United States
(12) Patent Application Publication
(10) Pub. No.: US 2025/0099853 A1
(43) Pub. Date: Mar. 27, 2025

(54) Methods For Simulating Audio Paths In A Virtual Environment

(71) Applicant: Sony Interactive Entertainment Europe Limited, London (GB)

(72) Inventors: Michael Lee Jones, London (GB); Christopher George Buchanan, London (GB); Calum Armstrong, London (GB); Alexei Ashton Derek Smith, London (GB); Maria Pilataki Manika, London (GB)

(73) Assignee: Sony Interactive Entertainment Europe Limited, London (GB)

(21) Appl. No.: 18/894,226

(22) Filed: Sep. 24, 2024

(30) Foreign Application Priority Data
Sep. 26, 2023 (GB) GB2314726.7

(51) Int. Cl. A63F 13/54

(52) U.S. Cl. CPC A63F 13/54; A63F 2300/6063

(57) ABSTRACT

The application provides a computer-implemented method for simulating a reflected audio path in a virtual environment, the virtual environment comprising a source, a receiver, an obstacle, and a sound-reflective boundary, the reflected audio path associated with reflection at the sound-reflective boundary, and the method comprising: simulating, by an image-source method, the reflected audio path between the source and the receiver, the image-source method comprising: generating, by mirroring the source in the sound-reflective boundary, a mirror image source, and determining a simulated reflected audio path along a line segment between the receiver and the mirror image source; generating, by mirroring the obstacle in the sound-reflective boundary, a mirror image obstacle; performing a line-of-sight check between the receiver and the mirror image source; and, when at least one of the obstacle and the mirror image obstacle lies along the line segment between the mirror image source and the receiver, performing an adjustment on the simulated reflected audio path.

### CROSS-REFERENCE TO RELATED APPLICATION

The present application claims priority from United Kingdom Patent Application No. GB2314726.7 filed Sep. 26, 2023, the disclosure of which is hereby incorporated herein by reference.

### TECHNICAL FIELD

The invention relates to methods of simulating audio paths for propagating audio signals in a virtual environment, and in particular, those in the fields of video gaming technology and video game development.

### BACKGROUND TO THE INVENTION

Interactive virtual environment systems combine audio and video to simulate the experience of immersive exploration of a three-dimensional virtual world, by rendering the environment as perceived from the viewpoint of an observer moving under real-time control by the user. Simulating a realistic perception of sound by the observer in the virtual environment is essential to provide an immersive experience, in which aural cues marry to the visual experience of the environment. Therefore, simulating the acoustics and determining how sound propagates through the environment is a crucial task.

Simulation of sound propagation involves simulating reflections of an audio signal emitted from an audio source as it propagates along a multitude of propagation paths to a receiver and is reflected from surfaces within the virtual environment. There are a number of methods of simulating sound propagation in virtual environments. The propagation of sound from a source to a receiver can be considered in three components: (1) direct sound, representing the earliest arriving and strongest sound wave, (2) early reflections describing low order reflections arriving in an initial time period, for example in the first ˜50 ms, where individual paths can be distinguished by the human ear, and (3) late reverberation, representing the sound when it has undergone many reflections and the human ear is no longer able to distinguish individual reflections.

The accurate simulation of early reflections is important as this is the component that proves the listener with most of the spatial information about an environment and so is crucial in adapting the user's experience of the sound to the specific virtual environment. Early reflections are usually calculated by geometric methods by explicitly computing linear propagation paths between a source and receiver, with vertices on surfaces in the virtual environment. The delay and attenuation can then be computed for each propagation path and the combination of these effects applied to an input audio signal to provide the simulated sound wave arriving at the receiver.

Image-source methods are often used for determining the propagation paths between a source and receiver, which involve computing specular reflection paths by considering virtual sources generated by mirroring the location of the audio source over each reflective surface of the environment. The path length between the virtual source and receiver provides the required delay to be applied to an audio signal propagated along the “true” reflected path between the source and receiver.

Known image-source methods are capable of effective simulation of lower order reflected audio paths in simple environments. However, the computational demands rapidly escalate when attempting to model reflections in more complex environments including obstacles, where routines need to determine which of the computed paths are valid and which are invalid due to being obstructed. Conventional image source methods tackle this problem by performing visibility or “line checks” along each portion of an audio path, including a portion incident on the reflective object and the portion involving the reflected path from the reflective objection to the receiver. Such line checks are required to determine whether or not any of the paths are obstructed by any sound-blocking objects present in the virtual environment.

When a computed audio path is determined to be unobstructed, the contribution of the path is used when determining the signal processing to be applied to an audio signal propagated between the source and receiver. This may include, for example, controlling the delay time of the audio signal according to the length of the specular path and other signal processing used to simulate the reflected audio signals. Where an obstruction is identified on a portion of an audio path, the contribution of the path may be removed from the simulation.

These line checks are computationally intensive, meaning that generally image source methods are restricted to use only in simulating low order reflections in simple environments. The computational demands are particularly relevant to simulating audio in video game environments where the simulations must be carried out at runtime in complex, dynamic virtual environments.

Accordingly, there is a need for an improved approach to simulating reflected audio paths in virtual environments that makes progress in addressing the above-described drawbacks of current image source approaches.

### SUMMARY OF THE INVENTION

According to a first aspect of the invention, there is provided a computer-implemented method for simulating a reflected audio path in a virtual environment, the virtual environment comprising a source, a receiver, an obstacle, and a sound-reflective boundary, the reflected audio path associated with reflection at the sound-reflective boundary, and the method comprising: simulating, by an image-source method, the reflected audio path between the source and the receiver, the image-source method comprising: generating, by mirroring the source in the sound-reflective boundary, a mirror image source, and determining a simulated reflected audio path along a line segment between the receiver and the mirror image source; generating, by mirroring the obstacle in the sound-reflective boundary, a mirror image obstacle; performing a line-of-sight check between the receiver and the mirror image source; and, when at least one of the obstacle and the mirror image obstacle lies along the line segment between the mirror image source and the receiver, performing an adjustment on the simulated reflected audio path. Preferably, the reflections at the sound-reflective boundary are specular reflections.

Advantageously, the method requires only a single line-of-sight check per source, thereby reducing the number of computations required for a processor to perform image-source methods that account for obstacles. In particular, rather than requiring a line check along every simulated path segment to check for an obstruction, as with conventional image source methods, the present method requires only a single line-of-sight check between the receiver and each virtual source. By replacing checks along the outgoing audio path (incident on the reflective surface) and the reflected path (from the reflective boundary) with a single line of sight check, the computational demands of the simulation are significantly reduced. Crucially, the benefits of the present method become more significant when simulating higher order reflections.

Whereas in conventional methods the number of line checks required grows exponentially, here only a single line of sight check is required for each virtual source. This allows simulation of reflected audio paths to higher orders with reduced computational demands, allowing more accurate simulations to be achieved and therefore more immersive virtual environments to be created.

The method may further comprise propagating an audio signal along the simulated audio paths between the source and receiver. In particular the method may comprise combining the effects of all simulated audio paths, including the adjusted audio path, and applying the combined effects to an audio signal emitted at the source. More specifically the method may comprise determining one or both of a delay value and an attenuation factor associated with each simulated path, combining the delay values and/or attenuation factors of the individual paths and applying the combined delay values and/or attenuation factors to the audio signal to be propagated.

An “audio path” is a path along which the audio signal travels between the source and receiver in the virtual environment. A “reflected audio path” preferably comprises an audio path which has been reflected from a reflective surface within the virtual environment.

Performing an adjustment to the simulated audio path preferably comprises performing an adjustment on the contribution of the audio path to a filter to be applied to an audio signal to be propagated, where the filter comprises the combined effects of the audio paths.

In an example of the first aspect, the virtual environment is a video gaming environment.

The above-described advantages are particularly relevant to video game environments, where the simulations are carried out at runtime and there is intense competition from multiple sources on the processing resources, and so any reduction in computational burden while maintaining or improving the quality of simulation is of huge significance.

In an example of the first aspect, the method is performed at runtime of a video game.

Advantageously, this method may be applied to a video gaming scenario, whereby improving the efficiency of audio reflection-related calculations will reduce latency for the user playing the video game and experiencing the virtual environment associated therewith. The listener experience is further improved when such calculations are performed at runtime, that is, in real time, during gameplay of the video game.

In an example of the first aspect, the performing an adjustment comprises: culling the simulated reflected audio path.

Advantageously, it may be determined that, when an obstruction is present on a boundary-reflected audio path between the receiver and the source, that is, when at least one of the obstacle and the mirror image obstacle lies along the line segment between the mirror image source and the receiver, that audio path is culled. This provides a computationally efficiency method to address obstructions, since it simply requires removing the effects of the audio path on the simulation of the propagation of an audio signal in the virtual environment. Culling the simulated reflected audio path preferably comprises removing the audio path from the simulation.

Rather than removing the contribution of the audio path entirely, in other examples the signal processing associated with the path is adjusted to account for the object. For example, the obstructed path may be provided with a filter to provide attenuation of an audio signal propagated along the path to account for the obstacle. The filter, or “attenuation factor” may be dependent on one or both of the properties of the obstruction and the audio signal to be propagated. In this way, an amplitude or EQ change may be associated with the path, that is applied to the propagated audio signal. The filter or “attenuation” factor may provide a frequency dependent amplitude change that is applied to the audio signal that is propagated along that audio path.

In an example of the first aspect, the performing an adjustment comprises: adjusting an attenuation factor associated with the simulated reflected audio path. The attenuation factor may comprise a filter (for example, a signal processing filter) where the filter preferably defines the effect of the obstacle on the path.

In an example of the first aspect, the adjusting an attenuation factor comprises: adjusting a first attenuation factor according to the length of the simulated reflected audio path. One aspect of the effect of the path, may be related to the length of the path, for example applying an attenuation associated with the length of the path.

In further preferable examples the attenuation factor comprises an effect on the propagated audio signal associated with the object. In particular an additional attenuation of the audio signal may be included where an object is identified as obstructing the path.

In an example of the first aspect, the adjusting an attenuation factor comprises: adjusting a second attenuation factor according to a property of the obstacle. In particular, an attenuation factor (i.e., a filter) may be determined based on one or more properties of the obstacle. The properties may include the size and/or constituent material of the obstacle

In an example of the first aspect, the adjusting an attenuation factor comprises: adjusting a third attenuation factor according to a property of the sound-reflective boundary.

Advantageously, it may be determined that, when an obstruction is present on a boundary-reflected audio path between the receiver and the source, that is, when at least one of the obstacle and the mirror image obstacle lies along the line segment between the mirror image source and the receiver, different attenuation factors associated with the audio path are adjusted to account for the presence and physical/acoustic properties of obstacles and boundaries.

In an example of the first aspect, the virtual environment comprises a plurality of sound-reflective boundaries, and the method further comprises simulating a plurality of reflected audio paths, each of the plurality of reflected audio paths associated with reflection at one of the plurality of sound-reflective boundaries.

Advantageously, the method may be extended to account for the presence of multiple boundaries each associated with an audio path from the source to the receiver which is simulated using the methods disclosed herein.

In an example of the first aspect, the virtual environment comprises a plurality of virtual objects; and the method further comprises: identifying at least one of the plurality of virtual objects as an obstacle; and generating, by mirroring the identified obstacle(s) in the boundary, corresponding mirror image obstacle(s) for only the identified obstacles.

Advantageously, the method may be extended to account for the presence of multiple virtual objects in the environment which may or may not be ‘obstacles’ to an audio path. The virtual objects which are determined to present an obstruction to travelling sound and which are therefore referred to as obstacles may then be accounted for using the methods disclosed herein.

In an example of the first aspect, each virtual object of the plurality of virtual objects comprises a tag indicating at least one property of the each virtual object, and wherein the identifying at least one of the plurality of virtual objects as an obstacle comprises: determining, based on the tag, whether the virtual object has properties that present an obstruction a propagating audio signal.

In an example of the first aspect, the method further comprises a preceding step of applying a respective tag to each virtual object of the plurality of virtual object, wherein the applying a respective tag comprises at least one of: manually tagging the virtual object; and automatically tagging the virtual object based on a property of the virtual object, wherein the property of the virtual object comprises one or more of size, material, and shape.

In an example of the first aspect, the automatically tagging the virtual object comprises: analysing, by machine vision, the virtual environment to determine whether the virtual object has properties which present an obstruction to a propagating audio signal.

Preferably a single line check is performed for each mirror image source. In particular, the image-source method may comprise generating a plurality of mirror image sources, each corresponding to a particular reflected audio path. The method may comprise performing a line-of sight check between the receiver and each mirror image source, and when at least one of the obstacle and the mirror image obstacle lies along the line segment between a particular mirror image source and the receiver, performing an adjustment on corresponding simulated reflected audio path. The method may preferably further comprise generating, by mirroring the source in each of a plurality of sound-reflective boundaries, a plurality of mirror image sources and generating, by mirroring the obstacle in each of the plurality of sound-reflective boundaries, a plurality of mirror image obstacles, where the method comprises performing a line of sight check between the receiver and each mirror image source.

In this way the method may be applied to a plurality of reflected audio paths, with only a single line check required for each mirror image source (i.e., each reflected audio path calculated). This provides increasingly efficiency over prior art image source methods which would require an increasing number of line checks when considering multiple reflections.

Advantageously, different methods may be applied to identify potentially sound-obstructing objects.

In an example of the first aspect, the source is configured to emit an input audio signal and the receiver is configured to receive an output audio signal, wherein the output audio signal comprises a version of the input audio adjusted according to the associated simulated audio paths.

In an example of the first aspect, each of the plurality of virtual objects is assigned a priority value representing the degree to which it presents an obstruction to a propagating audio signal, wherein only the virtual objects having the priority value above a threshold are identified as obstacles and used to generate corresponding mirror image obstacles.

In an example of the first aspect, the method further comprises: generating the output audio signal.

In an example of the first aspect, the method further comprises: simulating, by an image-source method, an nth order reflected audio path between the source and the receiver, the nth order reflected audio path associated with n reflections at sound-reflective boundaries within the virtual environment between the source and receiver, the image-source method comprising: generating, by sequentially mirroring the source in each of the sound reflective boundaries associated with the n reflections, an nth order mirror image source, and determining a simulated nth order reflected audio path along a line segment between the receiver and the nth order mirror image source; generating, by sequentially mirroring the obstacle in each of the sound-reflective boundaries associated with the n reflections, an nth order mirror image obstacle; performing a line-of-sight check between the receiver and the nth order mirror image source; and, when at least one of the obstacle and the nth order mirror image obstacle lies along the line segment between the nth order mirror image source and the receiver, performing an adjustment on the simulated nth order reflected audio path. Preferably, the reflections at the sound-reflective boundaries are specular reflections.

According to a second aspect of the invention, there is provided a computer program comprising instructions that, when executed by a computer, cause a computer to perform the method of the first aspect or any of the examples and variations associated therewith.

According to a third aspect of the invention, there is provided a computer gaming system comprising a processor configured to perform the method of the first aspect or any of the variations associated therewith.

Before exemplary embodiments of the invention are described in detail, concepts, and language relevant throughout this application are first described without reference to specific embodiments.

Reflection may be understood to mean the phenomenon wherein the direction of travel of a wavefront, physical or virtual, is altered at a boundary between different media such that the wavefront is returned to the medium wherefrom it originated. A ray may be understood to mean a curve which is drawn perpendicular to a wavefront, and which therefore points in the direction of wave energy propagation. A beam may be understood to mean a concentrated bundle of rays. Reflective interactions are governed by the first and second laws of reflection: the first law states that an incident ray, a reflected ray and a normal to the boundary all lie in the same plane; the second law states that an angle of incidence is equal to an angle of reflection, wherein said angles are measured from the normal to the respective ray. Sound reflection (also known as audio or acoustic reflection) is an example of a reflection phenomenon which may occur in both physical (that is, real-world) and virtual (that is, simulated) environments. This application is particularly concerned with the latter thereof however, the invention may be extended to augmented reality (AR) spaces wherein users and in-game audio are physically located in a real-world environment. In such an example as AR, users typically wear headwear having in-built loudspeakers wherefrom the in-game audio is output to the user themselves and, as such, the inventive methods disclosed herein can equally apply to the generation of reflected (computerised) audio for users moving in a physical/semi-virtual space.

Specular reflection may be understood to mean a reflection from a smooth, flat boundary; when specular reflection of a single incident beam occurs, a corresponding single reflected beam is produced according to the aforementioned first and second laws of reflection. Said reflected beam travels along what is known in the art as the specular path. An unreflected beam or ray travels along what is known in the art as the direct path. An image-source method, such as those in this application, may be utilised in the analysis of specular reflections. Specular reflection may be contrasted with diffuse reflection which occurs by reflection from a rough boundary; when diffuse reflection of a single incident beam occurs; multiple reflected rays are produced, wherein each of the multiple rays is moving in a different direction by virtue of the angle of the boundary at incidence location of each respective ray. Said reflected rays travel along what are known in the art as the scattered paths.

Virtual environment, when used herein, may be understood to mean any computer-generated artificially simulated environment wherein a user interacts with the environment and/or other users, ranging from fully immersive environments to augmented environments. Similarly, video gaming environment, when used herein, may be understood to mean any platform-computer-based, console-based, arcade-based, browser-based, mobile telephone-based, metaverse-based, livestreamed, VR, AR, or otherwise-which supports a video game and in which the game is played. As such, the video gaming environment comprises a simulation, such as a simulation of a fiction, a reality, or otherwise.

Source or audio source, when used herein, may be understood to mean that which generates sound/audio in the virtual environment. Examples of sources include, but are not limited to, loudspeakers playing audio; an NPC or other player/user speaking out loud; an explosion, gunshot, door slamming, or any other noise-generating event occurring in the gaming environment; user interface/interaction points; and the like.

Boundary, when used herein, may be understood to mean any reflective interface, such as an interface between any two or more virtual media located in the virtual environment. The boundaries discussed herein are capable of total internal reflection such that it is possible to generate specular reflections. Preferably, the set of boundaries represent a perimeter of the virtual environment. Boundaries discussed herein are preferably used as mirror lines in the mirroring of virtual objects to simulate mirror images of said objects. When referred to in the context of sound and soundwaves, sound-reflective boundary is also used. Examples of sound-reflective boundaries include, but are not limited to, walls, ceilings, floors, large furniture, buildings, non-solid media such as water or lava, and the like.

Obstacle or obstruction, when used herein, may be understood to mean any virtual object within the above-described boundaries that is capable of obstructing or attenuating sound travelling in the virtual environment. As such, the virtual object has properties that may affect an incident sound wave in many different ways dependent on audio frequency/amplitude, obstacle shape/material, and the like. Examples of virtual objects include, but are not limited to, furniture, other players, plants and trees, a door, a box, a window, and the like.

Image or mirror image, when used herein, may be understood to mean a mirrored simulation of an object in the virtual environment, and preferably one that is mirrored using a boundary as a mirror line. Mirroring may be achieved by any means known per se in the art, for example, a computer-implemented routine whereby the object to be mirrored is duplicated and the duplicate, i.e. the image, is considered to be equidistant from the chosen mirror line and at right angles to the mirror line but located on the other side of the mirror line to the original object.

Listener, when used herein, may be understood to mean a humanoid object such as a user or avatar thereof capable of receiving an audio signal, and preferably one capable of hearing such a signal by virtue of a loudspeaker/ears. The listener is situated at a receiving location or, alternatively, at a ‘receiver’, where receiver is a general term for a location in the virtual environment which is to receive an audio signal. In alternative examples, the listener may be understood to mean a non-humanoid object such as a virtual microphone. Such examples may include listening from a floating camera/video-camera, or listening to a virtual recording taken from a different location or a different room in a video gaming environment.

Before output sound is outputted at the receiver, the method may include a step of applying a Head Related Transfer Function (HRTF) as part of the determination of said output audio. An HRTF enables diegetic and/or nondiegetic audio to be generated that takes account of the structure of the human head and ear, such that even relatively simple audio generation devices may produce highly realistic 3D (or ‘binaural’) audio originating in the virtual environment.

Image-source method (also known in the art as an image-source routine or model), when used herein, may be understood to mean a mathematical-acoustic method for analysing and simulating specular reflections of sound. When a source (that is, an audio emitter) produces an audio signal (that is, a representation of a sound such as an electrical or mathematical representation) in a bounded medium, the sound which arrives at a listener (that is, the received/output audio signal) may reach the listener both directly and indirectly: the sound reaches the listener directly when it is not reflected when travelling along its audio path in the given medium; the sound reaches the listener indirectly when, by at least one point along its audio path, it is reflected from a boundary.

Each scenario requires nuanced calculations to accurately and realistically simulate the respective audio signals involved. The inventive routines disclosed herein are capable of handling any such combination of scenarios.

### BRIEF DESCRIPTION OF THE DRAWINGS

Specific embodiments of the invention are hereafter described by way of non-limiting examples and with reference to the accompanying figures, wherein:

FIG. 1 illustrates a method known in the state of the art.

FIG. 2 illustrates an exemplary first embodiment of the invention.

FIG. 3 illustrates an exemplary second embodiment of the invention.

FIG. 4 illustrates an exemplary third embodiment of the invention.

FIG. 5 illustrates an exemplary fourth embodiment of the invention.

FIG. 6 illustrates an exemplary flow diagram according to the invention.

### DETAILED DESCRIPTION

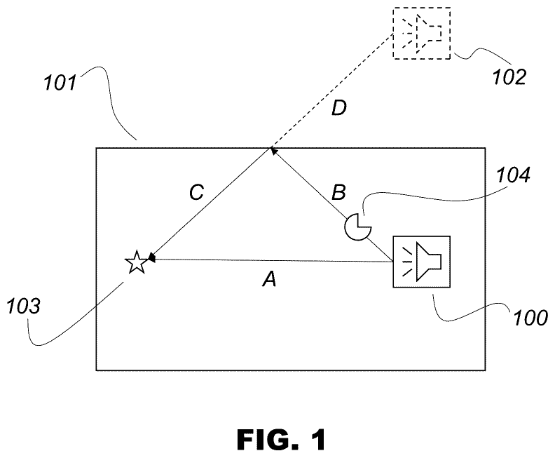

FIG. 1 illustrates a known method for simulating reflected audio signals in a virtual environment using an image source method.

The virtual environment comprises a source 100, a boundary 101, a receiver 103, and an obstacle 104. To simulate the perception of an audio signal emitted from the source 100 at the receiver's location 103, first a plurality of paths of the audio between the source 100 and receiver 103 must be determined. The length of these paths can then be used to determine the delay on the audio signal arriving at the receiving location via the respective path. Other changes to the emitted audio signal, such as attenuation due to path length and atmospheric scattering, can also be determined for each path. The effects of the plurality of paths are then combined to form a filter that may be applied to the audio signal to simulate the perception of the audio signal at the receiver location. The output models the acoustics of the room and gives the listener a sense of space and the localisation of the source, and so is particularly important for an immersive experience of the virtual environment.

Image source methods, as illustrated in FIG. 1, compute specular reflection paths (where specular reflection refers to perfect reflection in a single direction with no scattering) by firstly generating a mirror image source 102. As shown in FIG. 1, the mirror image source 102 is generated by mirroring the location of the source 100 in the boundary 101. If an identical audio signal is emitted from the mirror image source 102, it is experienced at the receiver location as a reflected audio signal from the source 100. In particular, the path length and direction of an audio signal arriving at the receiver location 103 from the virtual source 102 is the same as that of an audio signal from source 100 undergoing specular reflection at boundary 101. Therefore, to simulate specular reflections, a mirror image source can be generated for each reflective boundary, and a specular reflection path can be constructed from a line segment between each mirror image or “virtual” source 102 and the receiver 103. These paths between the virtual source and receiver can be used to determine the path delay (for example, relative to the most direct route between the source and receiver, shown as path A in FIG. 1), and attenuation, for the specular reflection path.

Describing FIG. 1 in more detail, the illustration depicts a directly incident path, indicated by ray A, and a specular reflection path indicated by incident ray B and reflected ray C. FIG. 1 also illustrates the specular reflection path generated using the image source method comprising ray D from the virtual source 102 and ray C. The path travelled by ray B followed by ray C is a specular reflected audio path. In the image source method, this path may be simulated as a direct path from the mirror image source 102, given the distance travelled by rays B and Cis equal to the distance travelled by rays D and C. To simulate the propagation of an audio signal emitted at the source location 100 to the receiver 103, based on the two paths shown, the contribution of the direct path A is combined with that of the simulated specular path, D and C. The effects of these paths (the delay determined by the path length, but also optionally attenuation and other effects) may be combined as a single filter which is convoluted with the audio signal to compute the signal received at the receiver location.

FIG. 1 illustrates just two paths A and (B, C) along which an audio signal propagates from the source 100 to the receiver 103 in the virtual environment. In a real simulation a much greater number of propagation paths will be determined and used to construct the final impulse response to be applied to the input signal. Further first order specular paths will be determined by reflecting the source in each of the other reflective surfaces 101, where the specular paths will be determined as described above for path (D, C). Higher order reflections, comprising reflections from several boundaries, are determined by iteratively reflecting the mirror image source(s) in further boundaries. For example a ray reflected from several boundaries is represented by a “higher-order” mirror image source, which has been mirrored in each of those boundaries in turn.

The above described method is suitable for simulating the propagation of an audio signal within a virtual environment in which the audio is unobstructed, but when there are potential obstacles within the virtual environment further steps must be included to determine which of the computed specular paths are obstructed, so that these can be modified or removed from the final impulse response. In prior art image-source methods, this involves checking each path segment, i.e. ray, to determine whether an obstacle is present in any of the audio paths. In the example of FIG. 1, only a single specular reflection path is shown, so this would involve checking for the presence of an object along path segments B and C, to determine that object 104 is present in the path. If all the first order (single reflection) paths were presented in FIG. 1, there could be four possible reflection paths in total so eight line checks corresponding to eight path segments would need to be carried out to check the incident and reflected path segment for each of the possible reflection paths, along with also checking the direct path.

Even in the simple 2D environment shown, when the simulation is extended to second order reflections there are 12 possible two-reflection combinations so this would involve checking 36 individual path segments (also referred to as line segments) to check if any are obstructed by an object in the virtual environment. Therefore, the computational demands quickly escalate when considering higher order reflections, particularly in a complex environment with multiple moving objects, where the simulations must be performed at runtime during gameplay. The restriction to low order reflections and simple virtual environments, limits the applicability of current image source methods and the high computational burden can reduce performance when applied in complex, dynamic 3D virtual environments such as video games.

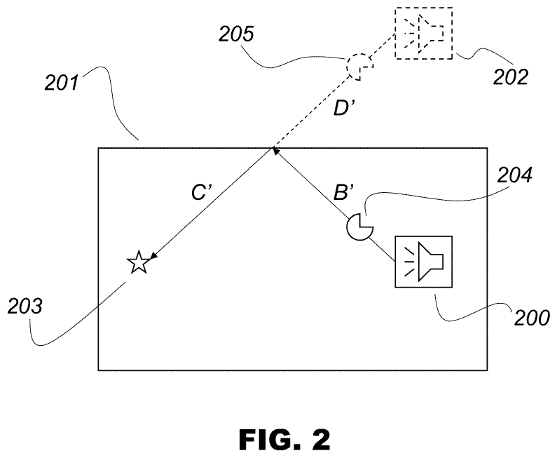

FIG. 2 illustrates an example of a method of simulating audio paths and propagating an audio signal within a virtual environment according to the present invention. As described above, an image source method is applied to simulate the specular reflection path (B′, C′). This involves mirroring the source 200 in the reflective boundary 201 to generate the mirror image source 202. The specular reflection path (B′, C′) is then simulated by determining a direct path (D′, C′) between the mirror image source 202 and the receiver 203, where the length, delay and direction of the path matches that of the specular reflection path (B′, C′) within the virtual environment. As in FIG. 1, the ray B′ incident on the reflective boundary 201 is obstructed by object 204. The standard image source method is extended by also mirroring the object 204 in the reflective boundary 201 to generate mirror image object 205. In the method of the present invention, rather than performing a line check along each path segment to determine the presence of an object, a single line-of-sight check is performed along the line segment between the receiver 203 and the mirror image source 202, i.e. line segment (C′, D′). This results in mirror image object 205 being identified as being present on the line segment and therefore indicating that the reflection path is obstructed. This contribution of this path to the simulation can therefore be removed or adjusted to account for the obstruction. This provides a more computationally efficient method of determining obstructions in an image source method, since only a single line-of-sight check need be performed, rather than multiple line checks.

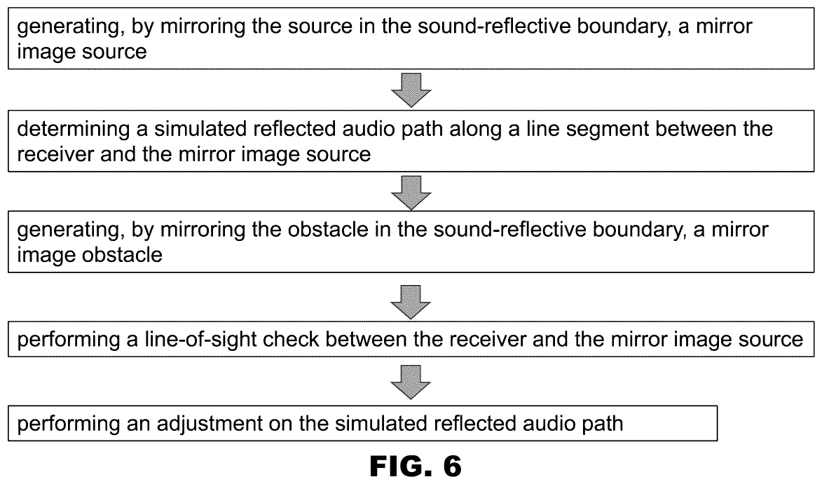

According to this first described example, there is provided a method for simulating the specular audio path (B′, C′) in the virtual environment, the virtual environment comprising the source 200, the receiver 203, the obstacle 204, and the sound-reflective boundary 201, the specular audio path (B′, C′) being associated with reflection at the sound-reflective boundary 201, and the method comprising: simulating, by an image-source method, the specular audio path (B′, C′) between the source 200 and the receiver 203, the image-source method comprising: generating, by mirroring the source 200 in the sound-reflective boundary 201, a mirror image source 202, and determining a simulated specular audio path (D′, C′) along a line segment between the receiver 203 and the mirror image source 202; generating, by mirroring the obstacle 204 in the sound-reflective boundary 201, a mirror image obstacle 205; performing a line-of-sight check between the receiver 203 and the mirror image source 202; and, since the mirror image obstacle 205 lies along the line segment D′ between the mirror image source 202 and the receiver 203, performing an adjustment on the simulated specular audio path (D′, C′). This method is also exemplified in consecutive steps in FIG. 6.

During simulation of the propagation of the audio signal at runtime, the audio signal to be emitted at the source location is determined and the combined contribution of the simulated paths (including the adjusted obstructed path) is applied to the audio signal to generate the output audio at the receiver location, which may be for example the location of the play character in a video game environment. In this way, the total output audio signal received at the receiver 203 comprises an adjusted version of the input audio signal originally emitted at the source 200. The total output audio signal, or a portion or otherwise further adjusted version thereof, may then be generated such that the user can hear said signal, for example through headphones, earphones, or other loudspeaker arrangements. Before the step of generation, a HRTF may be applied to adjust the panning of one or more audio vectors associated with the output audio signal.

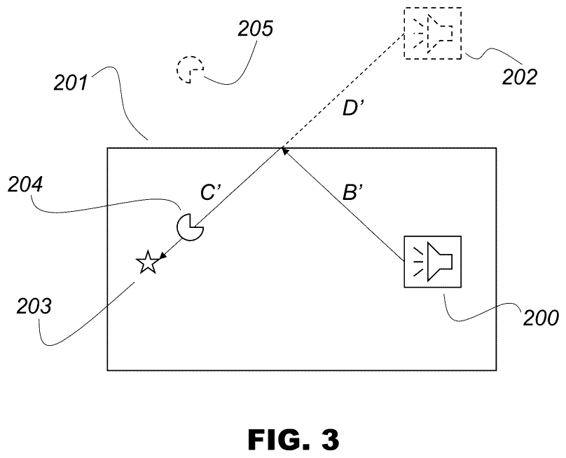

FIG. 3 illustrates another example of the method of the present invention, the only difference being that, in the virtual environment in which the method is applied, the object (i.e., the potential obstruction) 204 is positioned so as to obstruct the reflected ray C′ rather than incident ray B′ of the specular reflection path. As described above, a single line check is performed for each mirror image source 202 from the receiver 203 and mirror image source 202 to determine the presence of an obstruction along the path. FIG. 3 illustrates that, whether the obstruction is on the incident path as in FIG. 2 or on the reflected portion of the path as in FIG. 3, the present method identifies the presence of the obstacle so that the corresponding path can be adjusted. Examples of the adjustment that may be applied to an identified obstructed audio path are described in more detail below.

The ray B′ represents an input audio signal emitted by the source 200. The ray C′ represents an output audio signal received by the receiver 203. Although not shown in FIG. 3, it will be appreciated that there are many further rays emitted by the source 200 alongside ray B′. These further rays travel along other direct and specular paths: in the case of the latter, reflections occur at different boundaries to the boundary 201 and/or at different incidence locations along the boundary 201 (depending on the relative location, velocity or acceleration of the source and receiver), both of which may be simulated using the methods described herein. To simulate the complete audio signal received at the receiver 203, the method comprises superposing these audio signals that reach the receiver 203 via all possible direct and specular paths.

For clarity, the above described method has been illustrated for the simple case of first order reflected paths, but it can be extended to simulating higher order reflections. Importantly, whereas for prior art methods the computational requirement for higher order reflections increases exponentially, with the present invention a single line-of-sight check is required for any reflection order.

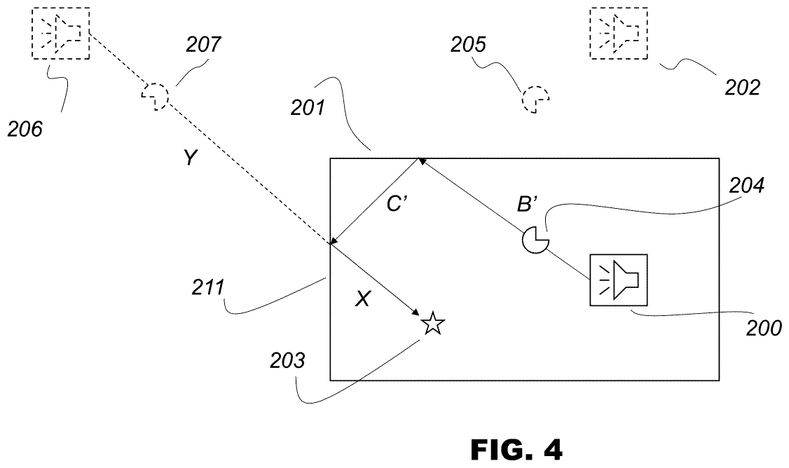

FIG. 4 illustrates the application of the method to a second order reflection, involving two reflections between a source 200 and receiver 203. A single second order reflected audio path is now represented by three line segments, (B′, C′, X). In this example, the acoustic effect of this audio path is simulated by mirroring both the source 200 and the obstacle 204 in each successive boundary upon which the sound wave is incident, for example, by mirroring the source 200 and obstacle 204 first in the upper reflective boundary 201 to get the first mirror image source 202 and obstacle 205, then by mirroring said mirror images 202 and 205 in the side reflective boundary 211 to get the final mirror image source 206 and obstacle 207 on which the remainder of the method is based. Mirroring in the boundaries may take place in any order, for example, the source and obstacle may be first mirrored in side boundary 211 and then again in upper boundary 201 arriving at the same result as before. In any case, both the presence of a sound obstruction on (B′, C′, X) and the path length attenuation of sound travelling along (B′, C′, X) may be calculated from a single line segment (Y, X); for example, checking for an obstructing object 204 now requires only a single line-of-sight check along (Y, X) to determine whether or not a mirror image obstacle 207 is present thereon, rather than line checks along each of X, C′ and B′ separately.

By way of example, the path length attenuation may be calculated by numerical simulation, by the use of a room transfer function, by considering reverberation effects, by considering the inverse square law of the acoustic power, or by any other means known per se in the art. Other attenuative effects may also be applied such as dispersion effects or absorption effects.

The method involved in this fourth embodiment of the invention may be extended to third order reflections by considering the effect of a third sequential boundary reflection and reflecting mirror image source 206 and mirror image obstacle 207 for a third time in a third boundary. Indeed, the method may be extended to nth order reflections by considering n sequential reflections of the virtual sound wave propagating in the virtual environment, the analysis of which is as before reduced to a single line-of-sight check.

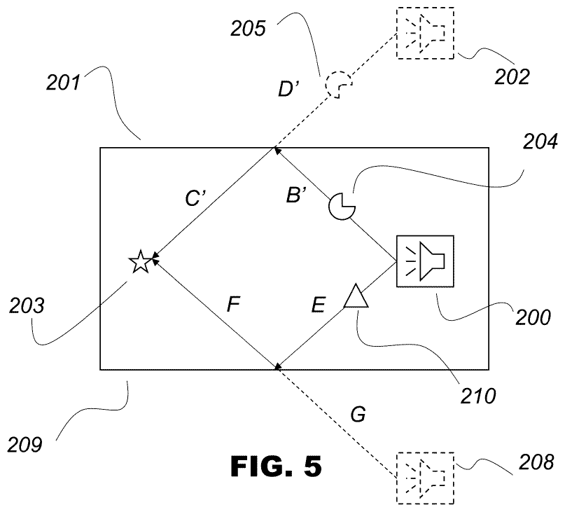

FIG. 5 illustrates a further possible extension to the method, involving an additional step of determining whether an identified object provides an obstruction to an audio signal, and optionally varying the adjustment to the audio path based on identified properties of the object.

FIG. 5 illustrates the application of the present method to a virtual environment comprising two objects 204, 206 that could potentially obstruct the simulated audio paths. In this example, two first order reflected audio paths, (B′, C) and (F, E), are being simulated: a first reflection from the lower reflective boundary 209, comprising incident ray E and reflected ray F, and a reflection from the upper reflective boundary 201, comprising incident ray B′ and reflected ray C′. Although only one additional virtual object 206 to the hitherto discussed virtual object, obstacle 204, is shown in FIG. 5, it will be appreciated that the virtual environment may contain a plurality of additional virtual objects, the methods disclosed herein being applied in succession to each virtual object of the plurality of virtual objects.

The virtual environment comprises a plurality of sound-reflective boundaries 201, 209 of which two are actively associated with the reflected audio paths (B′, C′) and (E, F) respectively. That is, in order to simulate a plurality of reflected audio paths, each of the plurality of reflected audio paths is associated with a specular reflection at one of the plurality of sound-reflective boundaries 201. Referring to FIG. 5, the boundary 201 is arranged in a 2D rectangle, however, the invention is not limited thereto, and it will be appreciated that, in variations on this embodiment, the boundary 201 may be arranged in any shape in any number of dimensions.

In this example the method comprises, prior to generating mirror image objects for each object, determining which of the objects have properties such that they will obstruct the audio paths and therefore an adjustment should be made. Preferably this step is performed prior to generating mirror image objects so that only those objects that are liable to obstruct the propagation of the audio need be mirrored, thereby increasing the computational efficiency. The step of determining whether the object will obstruct the audio may be carried out in a number of different ways. It may be as simple as applying a binary yes/no tag to the virtual object such that only objects tagged as obstructions are mirrored in a sound-reflective surface. In other examples, the virtual object may comprise more information in the tag or metadata usable in the method of simulation to determine whether the object will present an obstruction. For example, the tag may comprise information on the object's properties which are used during the simulation to determine whether the object is an obstruction.

The properties may include for example, one or more of: the size of the object, one or more constituent materials of the object, and its surface properties. These properties may be used to determine whether the object is an obstruction. In some cases this determination may be made on the basis of a specific audio signal to be propagated. For example, higher frequency, shorter wavelength signals may be obstructed by a smaller object more than lower frequency longer wavelength signals due to diffraction effects. Therefore the method may involve determining whether an object is an obstruction on the basis of both its properties and the properties of the audio signal to be propagated. In another example, the objects may not require a tag, but their properties may be determined at runtime to determine whether they present an obstruction. For example, an image processing method may be applied on the graphical objects to determine their size, constituent materials, and surface properties automatically.

In the example of FIG. 5 there are two objects 204, 2010, one of which is positioned in the lower reflected path (E, F)—object 2010—and one that is positioned in the upper reflected path (B′, C′)—objection 204. In this example, the first object 210 is determined as a small object that will not substantially obstruct the audio path, whereas the second object 204 is a large object that will present an obstruction. On the basis of this determination, only the second object 204 is mirrored in the reflective boundary to create mirror image object 205. The method then proceeds as above, with a line-of-sight check performed for each mirror image source 202, 208. In the example of FIG. 5 the line of sight checks confirm that reflected path (E, F) is unobstructed and reflected path (C′, D′) is obstructed by mirror image object 205. Therefore an adjustment is made to this reflected audio path to change its contribution to the final adjusted audio signal at receiver location 203. For example, the contribution of the path (C′, D′) may simply be removed or a greater attenuation may be applied to (C′, D′) than may be applied to (F, G). The contribution of the other path (F, G), despite object 210 otherwise being present in the path, is applied to the final output audio signal without considering the presence of any obstructions.

As described above, one possibility for determining which objects should be considered potential obstructions and mirrored involves using tags, where the tags may be applied at the design stage and used during simulation at runtime. The tag may be applied manually to virtual object 210, for example by the designer/programmer when creating the virtual environment. Alternatively, it is also possible to implement automatically tagging the virtual object 210 based on a property of the virtual object 210, said properties comprising one or more of size, material, and shape. In this case, the automatically tagging the virtual object 210 may comprise analysing, by machine vision, the virtual environment to determine whether the virtual object 210 has properties which present an obstruction to a propagating audio signal, such as the signals represented by rays E, F, B′ and C′. In this case, each virtual object 210 of the virtual environment comprises a tag indicating at least one property. The method may then comprise: identifying the virtual object 210 as an ‘obstacle’; and generating, by mirroring the identified obstacle 210 in the sound-reflective boundary 201, a corresponding mirror image obstacle only for the identified obstacles, wherein the identifying the virtual object as an obstacle comprises: determining, based on its tag, whether the virtual object has properties that present an obstruction a propagating audio signal. To determine whether or not a virtual object is significantly obstructing enough to be classified as an obstacle is a design consideration that will likely be undertaken by the sound designer.

In the case where the virtual environment comprises a plurality of virtual objects of which virtual object 210 is one, each of the plurality of virtual objects may be assigned a priority value representing the degree to which it presents an obstruction to a propagating audio signal, wherein only the virtual objects having the priority value above a threshold are identified as obstacles and used to generate corresponding mirror image obstacles. The priority values may be stored locally or remotely in a look-up table, generated automatically by a ML, DL, or AI system, assigned directly by the game developer or user. The degree to which an object presents an obstruction to a propagating audio signal is based on its inherent properties but may also be influenced by the medium and position in which it is located. Further, the degree of audio obstruction may be known per se from authoritative texts on vibro-acoustics; may be determined in real-time in the game environment, may be estimated using empirical values and assigned by the game developer.

In preferable examples of the all the aforementioned embodiments, the performing an adjustment on the simulated specular audio path (D′, C′) comprises either culling the simulated specular audio path (D′, C′) entirely (that is, no sound will be simulated as propagating along this path due to the presence of the obstacle 204/its mirror image 205) or adjusting one or more of several possible attenuation factors associated with the simulated specular audio path (D′, C′), wherein the attenuation factors are based on the length of the simulated reflected audio path (that is, the length of line segment D′ plus the length of line segment C′) and/or acoustic/physical properties of the obstacle 204/boundary 201. To cull the audio path may involve removing it entirely from the program code, attenuating any audio travelling along that path to such an extent that it is virtually inaudible, preventing any audio being emitted along that path in the first place, or any other means contemplated by the person skilled in the art. To adjust the audio path with an attenuation factor, on the other hand, may involve associating a frequency- or time-dependent transfer function, a dispersion relation, or other transformation to the audio path such that said attenuative representations can be later applied to functions representing input sound signals, said signals then being attenuated (or indeed amplified) accordingly. It will be appreciated by the person skilled in the art that, although references herein have been to ‘attenuation’ phenomena, such phenomena being frequency dependent can often cause certain frequencies/frequency ranges to be amplified while others are attenuated and, as such, the invention is not limited to only attenuation effects. Such amplification effects may occur by reflection from a parabolic boundary or wherein the reflective medium is impedance matched to the incident medium.

Further adjustments may include panning the spatial vector associated with the simulated reflected audio path to artificially alter the direction from which the sound reaches the receiver and thereby the user. Such effects may involve the use of a HRTF which can be applied to the sound signals reaching the receiver 203 before they are output to the user.

The methods described herein may be implemented by hardware, software, or any combinations thereof. Where a software implementation is employed to implement an embodiment of the invention or any feature therein, it will be appreciated that such software, and any non-transitory machine-readable storage media by which such software is provided, are also to be considered embodiments of the invention.

1. A computer-implemented method for simulating a reflected audio path in a virtual environment, the virtual environment including a source, a receiver, an obstacle, and a sound-reflective boundary, the reflected audio path associated with a reflection at the sound-reflective boundary, the method comprising:
simulating, by an image-source method, the reflected audio path between the source and the receiver, the image-source method comprising:
generating, by mirroring the source in the sound-reflective boundary, a mirror image source; and
determining the simulated reflected audio path along a line segment between the receiver and the mirror image source;
generating, by mirroring the obstacle in the sound-reflective boundary, a mirror image obstacle;
performing a line-of-sight check between the receiver and the mirror image source to determine that at least one of the obstacle or the mirror image obstacle lies along a line segment between the mirror image source and the receiver; and
performing an adjustment on the simulated reflected audio path.

2. The method of claim 1, wherein the virtual environment is a video gaming environment.

3. The method of claim 2, wherein the method is performed at runtime of a video game.

4. The method of claim 1, wherein performing an adjustment comprises culling the simulated reflected audio path.

5. The method of claim 1, wherein performing an adjustment comprises adjusting an attenuation factor associated with the simulated reflected audio path.

6. The method of claim 5, wherein the attenuation factor is adjusted according to a length of the simulated reflected audio path.

7. The method of claim 5, wherein the attenuation factor is adjusted according to a property of the obstacle.

8. The method of claim 5, wherein the attenuation factor is adjusted according to a property of the sound-reflective boundary.

9. The method of claim 1, wherein:
the virtual environment comprises a plurality of sound-reflective boundaries; and
the method further comprises simulating a plurality of reflected audio paths, each of the plurality of reflected audio paths associated with a reflection at one of the plurality of sound-reflective boundaries.

10. The method of claim 1, wherein:
the virtual environment comprises a plurality of virtual objects; and
the method further comprises:
identifying at least one of the plurality of virtual objects as an obstacle; and
generating, by mirroring the identified obstacle in the sound-reflective boundary, a corresponding mirror image obstacle for the identified obstacle.

11. The method of claim 10, wherein:
each virtual object of the plurality of virtual objects comprises a tag indicating at least one property of the virtual object; and
identifying at least one of the plurality of virtual objects as an obstacle comprises determining, based on the tag, whether the virtual object has properties that present an obstruction to a propagating audio signal.

12. The method of claim 11, further comprising applying a respective tag to each virtual object of the plurality of virtual objects, by performing at least one of:
manually tagging the virtual object; or
automatically tagging the virtual object based on a property of the virtual object.

13. The method of claim 12, wherein the property of the virtual object comprises at least one of a size, material, or shape.

14. The method of claim 12, wherein automatically tagging the virtual object comprises analysing, by machine vision, the virtual environment to determine whether the virtual object has properties which present an obstruction to a propagating audio signal.

15. The method of claim 10, wherein each of the plurality of virtual objects is assigned a priority value representing a degree to which it presents an obstruction to a propagating audio signal, the virtual objects having the priority value above a threshold being identified as obstacles and used to generate corresponding mirror image obstacles.

16. The method of claim 1, wherein the source is configured to emit an input audio signal and the receiver is configured to receive an output audio signal, wherein the output audio signal comprises a version of the input audio adjusted according to the adjusted simulated reflected audio path.

17. The method of claim 16, further comprising generating the output audio signal.

18. A computer program comprising instructions that, when executed by a computer, cause the computer to perform the method of claim 1.

19. A computer gaming system comprising a processor configured to perform the method of claim 1.

20. A computer-implemented method for simulating an n^{th} order reflected audio path in a virtual environment, the virtual environment including a source, a receiver, an obstacle, and n sound-reflective boundaries, the n^{th} order reflected audio path associated with n reflections at sound-reflective boundaries, the method comprising:
simulating, by an image-source method, an n^{th} order reflected audio path between the source and the receiver, the image-source method comprising:
generating, by sequentially mirroring the source in each of the sound reflective boundaries associated with the n reflections, an n^{th} order mirror image source; and
determining a simulated n^{th} order reflected audio path along a line segment between the receiver and the n^{th} order mirror image source;
generating, by sequentially mirroring the obstacle in each of the sound-reflective boundaries associated with the n reflections, an n^{th} order mirror image obstacle;
performing a line-of-sight check between the receiver and the n^{th} order mirror image source to determine that at least one of the obstacle and the n^{th} order mirror image obstacle lies along a line segment between the n^{th} order mirror image source and the receiver; and
performing an adjustment on the simulated n^{th} order reflected audio path.
